(19) United States
(12) Patent Application Publication
(10) Pub. No.: US 2010/0164221 A1
(43) Pub. Date: Jul. 1, 2010

(54) Pipe Coupling

(76) Inventor: Alexander Rinderhofer, Klein St. Paul (AT)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 12/733,202

(22) PCT Filed: Jul. 23, 2008
(86) PCT No.: PCT/EP2008/006009

§ 371 Date: Feb. 17, 2010

(30) Foreign Application Priority Data
Aug. 22, 2007 (DE) 102007039582.7

(51) Int. Cl. F16L 47/02; F16L 55/00

(52) U.S. Cl. 285/21.1; 285/24

(57) ABSTRACT

The invention relates to a pipe coupling, in particular for connecting water-carrying pipes, such as drinking water pipes, sewage pipes, well pipes, etc.

The invention relates to a pipe coupling, in particular for connecting water-carrying pipes, such as drinking water pipes, sewage pipes, well pipes, etc.

Such a pipe coupling is used to connect two pipes. The pipe coupling has to be configured such that it provides a liquid-tight connection of adjacent pipes. In addition, it has to have the mechanical stability that is necessary for the respective application. Usually, supports are provided along pipe systems that consist of several pipes and pipe couplings to preclude as much as possible tensile forces acting on the pipes. The installation of supports is not always possible, however. Here, pipe couplings are required that make possible a connection of adjacent pipes that guarantees tensile strength.

This also applies when laying pipelines that consist of pipe sections and pipe couplings in soft soils. High mechanical stresses on these soils act on the pipe sections and couplings that are laid in the ground. Earth-moving and expansion often result so that pipes that consist of pipe couplings slip out if special actions are not implemented.

Stricter requirements on connections of adjacent pipes that guarantee tensile strength furthermore are produced in well sinking.

For the above-mentioned applications, pipe couplings, as produced from DE 27 44 739 A1, U.S. Pat. No. 4,174,125 A and EP 1 102 943 B1, are now used.

The known pipe couplings consist of tubular pipe collars that are made of fiber-glass-reinforced plastic and a rubber-elastic seal with various sealing lips arranged on the inside.

Despite the use of fiber-glass-reinforced plastics such as polyester resin (with different additives and aggregates), the tensile strength of the known pipe couplings frequently is insufficient for the above-mentioned applications.

The object of the invention is therefore to offer a pipe coupling of this type that makes possible a reliable and durable connection of adjacent pipe sections in a design that guarantees tensile strength.

The invention is based on the finding that this object can be achieved by a special, multi-layer design of the coupling wall. In this case, the basic design of a pipe coupling is specified: a seal on the inside that is manufactured in a corresponding pipe collar (on the outside).

In the prior art, the pipe collar—as stated—consists of fiber-glass-reinforced plastic. In this case, there are basically two technologies:

The coupling pipe collar is produced in a centrifuging process. The fiber reinforcement in this case consists of cut glass fibers in irregular orientation.

The pipe collar is produced in a winding process. In this process, the fibers are longer (continuous fibers) and run primarily in the peripheral direction of the pipe collar.

The central idea of the invention, however, consists in forming different layers of the pipe coupling with different fiber orientation.

In principle, the wall design of the pipe coupling can have any number of layers; according to the invention, at least two layers are essential for achieving the object:
The wall has to have a fiber-reinforced outer plastic layer in which the fibers primarily run in the axial direction of the coupling, and
The wall has to have a fiber-reinforced inner plastic layer in which the fibers primarily run in the peripheral direction of the coupling.

To this is added, of course, the seal, which fits with the inner plastic layer on the inside.

The minimum wall design is accordingly in three parts: outer plastic layer, inner plastic layer, seal. This wall design is sufficient to achieve the desired object and to provide a high-quality coupling that guarantees tensile strength.

If necessary, however, additional layers can also appear, for example an outer cover layer or an intermediate layer between outer and inner plastic layers.

The inner plastic layer can be, for example, a layer that is produced in the winding process. In this case, it is used to absorb the inside pressure of the related pipeline system. The fibers that are oriented tangentially (i.e., in the peripheral direction of the pipe coupling) provide an excellent strength of this layer in the peripheral direction.

The outer plastic layer with its essentially axially-oriented fibers is the decisive layer for increasing the axial tensile strength of the coupling. This object is achieved in a special way when the fibers (threads) have a corresponding length. The outer layer can be formed such that the individual fibers of the reinforcement extend over the entire axial length of the pipe coupling, i.e., from one end to the other. At a coupling length of 50 cm, the fibers/threads are then at least 50 cm long, often longer, since they follow the contour of the coupling.

The outer plastic layer should have at least 9/10 of the length of the coupling in the axial direction of the coupling in order not to pose a threat to the advantageous tensile strength. Best of all, the outer plastic layer runs over the entire axial length of the coupling.

The inner plastic layer can be shorter. According to one embodiment, in the axial direction of the coupling, it has at most 8/10 of the length of the coupling.

This makes possible embodiments in which end sections of the outer plastic layer have a greater wall thickness than the sections in between. Thus, the outer plastic layer in the axial end sections of the coupling can have a wall thickness that corresponds to the wall thickness of the coupling or is at least greater than 9/10 of the wall thickness of the coupling in these end sections.

In this case, embodiments are produced as they are also shown in the subsequent description of the figures. In this case, the inner plastic layer is overlapped on the ends by the outer plastic layer.

In turn, the seal usually has a length that in the axial direction of the coupling corresponds at most to the length of the inner plastic layer. It can also be shorter, such that the inner plastic layer engages the seal on the axial end sections.

The fibers of the inner plastic layer can be thus-mentioned continuous fibers, which run several times around the coupling pipe. Also, the following applies here: the longer the fibers, the greater the tensile strength.

The seal can be bonded to the inner plastic layer. It is also possible to cross-link the seal chemically with the inner plastic layer, as is proposed in EP 1 102 943 B1. Also, a mechanical attachment is possible.

Preferably, the seal is in one part. It can—in the axial direction of the coupling—be designed in mirror-image, starting from a center sealing ring that projects inward and against which the pipes to be connected strike the opposite sides.

Of course, the coupling can also be designed asymmetrically with respect to the seal thereof.

An embodiment was already mentioned, in which the end sections of the outer plastic layer have a larger wall thickness than the sections in between, whereby the wall thickness of the plastic layer can be the same as the wall thickness of the coupling in this area.

This embodiment—but also other configurations of the pipe coupling according to the invention—provide the possibility of designing the inside wall in the area of its two end sections (observed in the axial direction of the coupling) with circumferential annular recesses, namely preferably in-situ during production.

These annular recesses serve to hold tension rods, which are threaded through the coupling wall in the connection of two pipes and lie partially in the above-mentioned annular recess and partially in a corresponding annular recess in the area of the pipe ends after installation and thus provide a snug connection that guarantees tensile strength. Also, this is depicted by way of example in the description of the figures below.

The special advantage lies in the fact that the recesses are formed during production of the coupling. In the prior art, the corresponding recesses were milled out as grooves. In this case, the fibers were cut through, and thus the tensile strength and shear resistance of the coupling were significantly weakened. According to the invention, by the described production process, the fibers can be embedded around the recess and thus continuously embedded in the plastic matrix.

In other words: the fibers of the outer plastic layer follow the shape of the inside wall at least in the area of the inside wall.

Additional features of the invention follow from the features of the subclaims as well as the other application documents. This includes that at least one of the plastic layers consists of a hardened, fiber-glass-reinforced polyester resin, although other plastic systems and types of fibers are also possible.

The invention is explained in more detail below based on an embodiment. Here, in each case in schematic form,

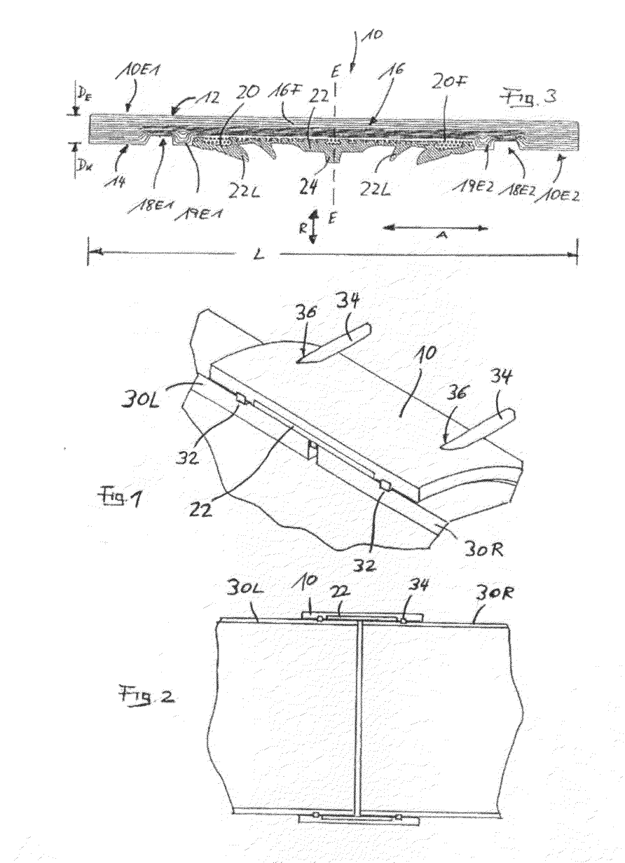

FIG. 1 shows a perspective partial view of a pipe coupling according to the invention,

FIG. 2 shows a longitudinal section through the coupling according to FIG. 1 in the installed state with two pipe sections,

FIG. 3 shows a longitudinal section through the coupling wall for depicting the wall design.

In the figures, components that are the same or that act the same are depicted with the same reference numbers.

FIG. 3 shows an example of a wall design of the pipe coupling that is depicted in FIGS. 1, 2. From outside to inside, i.e., between an outside wall 12 and an inside wall 14, the wall design is characterized by three zones:

An outer plastic layer 16 that is reinforced with fibers 16F and in which the fibers 16F run primarily in the axial direction of the coupling 10, i.e., from left to right in the drawing.

In the end sections 10E1, 10E2, the outer plastic layer 16 has a wall thickness D_{E} that corresponds to the wall thickness D_{K} of the coupling 10 in this end section.

In the end sections 10E1, 10E2 of the coupling 10, recesses 18E1, 18E2 are also formed on the inside that in section (FIG. 3) have a roughly rectangular profile.

As the figure shows, the fibers 16F run throughout over the entire axial length L of the pipe coupling 10 and around the latter in the area of the groovelike recesses 18E1, 18E2. Because the fibers run all the way around, the outer plastic layer 16 has an extremely high tensile strength/shear resistance (in the axial direction of arrow A).

An inner plastic layer 20 runs on the inside adjacent to the outer plastic layer 16. The inner plastic layer 20 is (in the axial direction of the coupling 10) shorter than the outer plastic layer 16. It runs between the two inner sections 19E1, 19E2 of the recesses 18E1, 18E2.

Like the outer plastic layer 16, the inner plastic layer 20 consists of hardened polyester resin. Like the outer plastic layer 16, the fibers inside the layer 20 consist of glass fibers, which, in the case of the layer 20, however, run in the peripheral direction of the pipe coupling 10, so that in the sectional view according to FIG. 3, only the cut surfaces of the individual fibers 20F can be detected.

The layer 20 is produced in the winding process and, in addition to good compressive strength, has an extremely high tensile strength in the tangential direction (arrow R) of the coupling 10 to absorb the inside pressure of the pipe.

The inner plastic layer 20 is designed with projections and rebounds, in which corresponding projections and rebounds of a seal 22 lie. The seal 22 consists of ethylene-propylene-diene terpolymer (EPDM), a rubbery, rubber-elastic material.

The seal 22 has several sealing lips 22L that project inward. Since the concrete design of the seal is not essential to the idea according to the invention, this point will not be considered in more detail. The seal is preferably to be configured such that the medium (water), which flows through the pipe, has no contact with the coupling material (the pipe collar).

In any case, it is important that the seal 22 be in one part and in the depicted embodiment be symmetrical (mirror-symmetrical) to a plane E-E, which runs through a center arm 24 of the seal 22.

The plastic layers 16, 20 are chemically cross-linked to one another, since both were applied in the same winding process (wet in wet).

FIGS. 1, 2 show the coupling 10 that couples two pipe sections 30L, 30R. Both pipe sections 30L, 30R have circumferential grooves 32 on the ends on their respective outside walls, which in the coupling position oppose the annular recesses 18E1, 18E2 of the coupling 10 such that the coupling rods 34 can be threaded through prepared openings 36 in the outer plastic layer 16 until they lie partially in the recesses 18E1, 18E2 and partially in the grooves 32 as depicted in the figures, and thus provide a snug connection between coupling 10 and pipes 30L, 30R that guarantees tensile strength.

The seal 22 lies above the pipes 30L, 30R, the center arm 24 of the seal 22 between the ends of the pipes 30L, 30R.

1. Pipe coupling with the following wall design between an outside wall (12) and an inside wall (14):
a) An outer plastic layer (16) that is reinforced with fibers (16F) and in which the fibers (16F) run primarily in the axial direction of the coupling (10),
b) An inner plastic layer (20) that is reinforced with fibers (20F) and that is overlapped on the ends by the outer plastic layer (16) and in which the fibers (20F) run primarily in the peripheral direction of the coupling (10),
c) A seal (22) in one part that consists of a deformable material, characterized in that
the medium, which flows through the pipe, has no contact with the coupling material.

2. Pipe coupling according to claim 1, whose outer plastic layer (16), in the axial direction of the coupling (10), has at least 9/10 of the length of the coupling (10).

3. Pipe coupling according to claim 1, whose inner plastic layer (20), in the axial direction of the coupling (10), has at most 8/10 of the length of the coupling (10).

4. Coupling according to claim 1, whose seal (22), in the axial direction of the coupling (10), has at most the length of the inner plastic layer (20).

5. Coupling according to claim 1, whose outer plastic layer (16) has fibers (16F) that primarily extend over the entire length of the outer plastic layer (16) in the axial direction of the coupling (10).

6. Coupling according to claim 1, whose inner plastic layer (20) has fibers (20F) that extend primarily over at least 360° of the inner plastic layer (20) in the peripheral direction thereof.

7. Coupling according to claim 1, whose inner plastic layer (20) is a plastic layer that is applied in the winding process.

8. Coupling according to claim 1, whose seal (22) is bonded to the inner plastic layer (20).

9. Coupling according to claim 1, whose seal (22) is in one part.

10. Coupling according to claim 1, in which end sections (10E1, 10E2) of the outer plastic layer (16) have a larger wall thickness (D_{E}) than the sections of the plastic layer (16) in between.

11. Coupling according to claim 10, in which the wall thickness (D_{E}) of the end sections (10E1, 10E2) of the outer plastic layer (16) is larger than 9/10 of the wall thickness (D_{K}) of the coupling (10) in these end sections (10E1, 10E2).

12. Coupling according to claim 1 or 10, whose inside wall (14), considered at each of its two end sections, in the axial direction of the coupling (10), has at least one circumferential, annular recess (18E1, 18E2).

13. Coupling according to claim 12, whose recesses (18E1, 18E2) are formed in-situ during production.

14. Coupling according to claim 1, in which the fibers (16F) of the outer plastic layer (16) follow the shape of the inside wall (14) at least in the area of the inside wall (14).

15. Coupling according to claim 1, in which at least one of the plastic layers (16, 20) consists of a hardened, fiber-glass-reinforced polyester resin.
